(19) United States
(12) Patent Application Publication
(10) Pub. No.: US 2003/0189635 A1
(43) Pub. Date: Oct. 9, 2003

(54) Method for calibrating spatial light modulator against profile

(75) Inventors: Bryan M. Comeau, Atkinson, NH (US); Dwayne Bailey, North Andover, MA (US); Roy D. Allen, North Andover, MA (US); David Joel Romano, Lowell, MA (US)

Correspondence Address: AGFA CORPORATION, LAW & PATENT DEPARTMENT, 200 BALLARDVALE STREET, WILMINGTON, MA, 01887, US

(73) Assignee: Agfa Corporation

(21) Appl. No.: 10/230,535

(22) Filed: Aug. 29, 2002

Related U.S. Application Data
(63) Continuation-in-part of application No. 10/117,475, filed on Apr. 5, 2002.

(51) Int. Cl. B41J 2/47

(52) U.S. Cl. 347/255; 347/239

(57) ABSTRACT

A calibration system for a platesetter or imagesetter is applicable to systems that have a media drum and a carriage, including a light source and a spatial light modulator for selectively exposing the media that is held against the drum. The invention can be applied to internal or external drum systems. The calibration system comprises a calibration sensor that is scanned relative to the spatial light modulator. The controller then analyzes the response of the calibration sensor to generate calibration information that is used to configure the spatial light modulator. The use of this calibration sensor allows for job-to-job calibration of the spatial light modulator, in one example, that ensures the generation of a high quality images, without banding, for example, on the media. This calibration system is also used to detect a best focus position for projection optics by measuring a contrast ratio between exposure and OFF light levels for various focus settings. It selects the best focus position in response to the contrast ratio.

### RELATED APPLICATIONS

This application is a continuation-in-part application of U.S. patent application Ser. No. 10/117,475 filed on Apr. 5, 2002 by the present inventors. The '475 application is incorporated herein in its entirety by this reference.

### BACKGROUND OF THE INVENTION

Spatial light modulators (SLM's) are used in a variety of applications to modulate light, because they can be modulated at kilohertz rates and can handle relatively high levels of power. They can be used in transmission and/or reflection.

For high power applications, SLM's based on micro-electro mechanical system (MEMS) are typically used. These MEMS can be one dimensional or two dimensional arrays of elements. For example, grating light valve (GLV) devices are based on diffractive optical MEMS. They are comprised of a series of tiny ribbons on the surface of a silicon substrate that are typically electrostatically driven to cause the ribbons to move by a fraction of a wavelength of the relevant light. This creates a dynamic, tunable grating that precisely varies the amount of light that is diffracted or reflected.

Other examples include tilt mirror MEMS devices in which the movement and positioning of mirrors is performed in order to guide a beam of light. These are very common in fiber optic systems and display devices.

More recently SLM's have been proposed for use in printing systems. Their high-speed modulation enables a substrate to be exposed very quickly with high resolution. Moreover, these MEMS SLMs can have the high power handling requirements that are required to expose the printing substrates.

For example, imagesetters and platesetters are used to expose the media that are used in many conventional offset printing systems. Imagesetters are typically used to expose film that is then used to make the plates for the printing system. Platesetters are used to directly expose the plates. Systems are being proposed that use a combination of a light source and a spatial light modulator (SLM). Such modulators are usually based on liquid crystal technology. In one example, the light source is pulsed with a fixed periodicity. The data determining the plate exposure is then used to drive the spatial light modulator. This results in the media being exposed in a series of separate sub-images in the fashion of a stepper. As a result, the speed of operation is no longer limited by the rate at which the laser can be modulated or the power that can be extracted from that single laser.

### SUMMARY OF THE INVENTION

Calibration of these SLMs is very important especially in display or print applications. The human eye can be very sensitive to artifacts in the resulting image that is produced by the print or display imaging system. This is especially true if the artifacts result in lines or regions of different shading that extend across the image.

One example of this is banding in print media. It arises when elements of the imaging system expose the print media at different exposure levels. The result can be horizontal or diagonal lines that extend across the image, which, even if very faint, many times can be discerned by the human eye. This results in an unacceptable image.

This characteristic has been a barrier to the implementation of SLM devices in printing applications and especially commercial printing applications. As a result, many imaging systems used in printing applications still use a conventional modulated raster-scanned laser dot to expose the photo or thermally sensitive media.

One solution to avoid the generation of these artifacts in the generated image is to calibrate the SLM to achieve uniform exposure. This is typically done by equalizing the transmitted intensity across the width of the SLM. These calibration routines, however, must be very robust in order to ensure that all discernable artifacts are avoided.

Moreover, in many situations, noise sources can also arise in the imaging system. This creates differences in how the SLM behaves during calibration and operation. The calibration process must also address these issues.

In general, according to one aspect, the invention features a method for calibrating a spatial light modulator. This method comprises detecting intensity levels of light provided by elements of the spatial light modulator. These intensity levels are then compared to a calibration profile for the spatial light modulator. Control levels for the elements of the spatial light modulator are then determined so that the provided intensity levels correspond to the calibration profile.

A number of different techniques can be used to determine the calibration profile. For example, a uniform threshold can be applied across the spatial light modulator. In another example, however, variable intensity levels are provided across the spatial light modulator. As a result, the calibration can be defined to compensate for modulation dynamics of the spatial light modulator or other noise sources.

The calibration profile can also be defined to achieve a target pixel size or a target pixel intensity spatial profile.

In specific embodiments, the spatial light modulator works in transmission with the transmitted light being directed at a recording medium. Some other systems, however, including tilt mirrors, typically work in reflection. In the specific implementation, a servo system is used to minimize the error between the detected intensity level and the calibration profile to thereby control the SLM in response to the calibration profile.

In the current implementation, the SLM is driven in a binary fashion. This is most applicable to printing applications where a media is being exposed in order to manufacture printing plates, for example.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is a plan view of a platesetter imaging engine to which the present invention is applicable;

FIG. 2 is a flow diagram illustrating a pre-plate exposure calibration sequence according to the present invention;

FIG. 3 is a flow diagram showing a servo calibration process for setting the On DAC control level data according to the present invention;

FIG. 4 is a flow diagram of ON level calibration subsequence showing an inventive process for setting exposure levels across the spatial light modulator according to a calibration profile;

FIG. 5 is a plot showing precalibration and post calibration exposure level data as a function of shutter position in the spatial light modulator used in the present invention illustrating a uniform intensity level;

FIG. 6 is a schematic diagram illustrating a pixel intensity profile;

FIG. 7 is a plot of a non-uniform calibration profile for controlling a pixel intensity profile according to the present invention;

FIG. 8 is a flow diagram of the OFF level calibration subsequence showing the process for providing uniformity in the dark level across the spatial light modulator according to the present invention;

FIG. 9 is a plot of precalibration and post calibration dark level data as a function of shutter position in the spatial light modulator used in the present invention;

FIG. 10 is a plot of OFF level control data and ON level control data as a function of shutter position, these data being used to control the exposure level and dark level for a calibrated spatial light modulator according to the present invention;

FIG. 11 is a flow diagram showing a best focus calibration subsequence according to the present invention;

FIG. 12 is a plot of exposure level and dark level data for different focus settings illustrating the change in the contrast ratio with changes in the focus setting; and

FIG. 13 is a flow diagram showing an exposure level calibration subsequence according to the present invention.

### DETAILED DESCRIPTION OF THE PREFERRED EMBODIMENTS

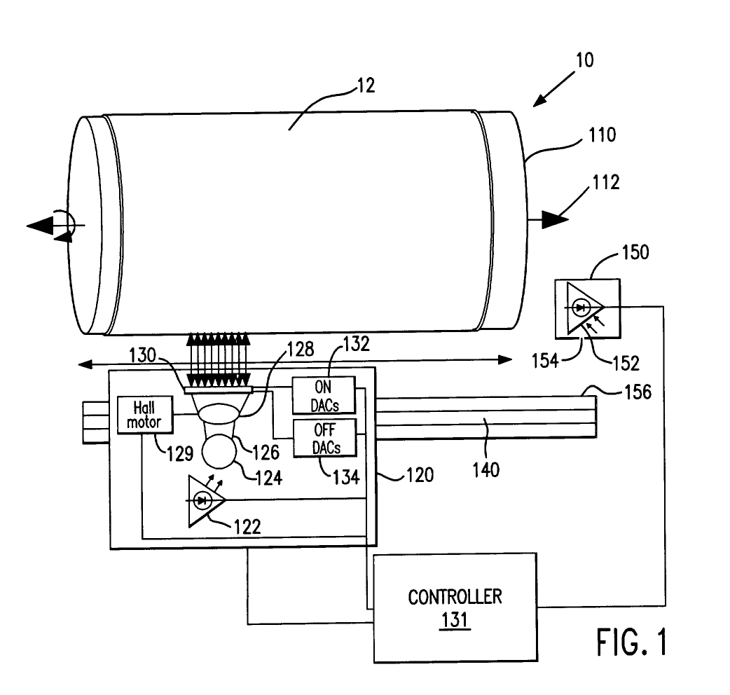

FIG. 1 shows an imaging engine 10 that has been constructed according to the principles of the present invention. This imaging engine 10 can be deployed in a platesetter in which the media 12 is a photosensitive plate. In another implementation, it is deployed in an imagesetter in which the media 12 is film.

The imaging engine 10 comprises a media drum 110. The drum 110 revolves on an axis-of-rotation 112 that is co-axial with the drum 110. In the illustrated example, the media 12 is held against the outside of the drum 110. This configuration is typically termed an external drum configuration.

In an alternative implementation, the media 12 is held along an inner side of the drum 110 to provide an internal drum configuration.

A carriage 120 is disposed adjacent to the drum 110. It is controlled by a controller 131 to move along track 140 that extends parallel to the rotational axis 112 of the drum 110.

In the internal drum configuration, the carriage 120 moves within the drum 110 and is typically supported on a cantilever-like track, generally extending down through the center of the drum 110.

In either case, the carriage 120 supports a light source 122. In the present implementation, this light source 122 comprises an array of laser diodes. The beams from these laser diodes are combined into a single output and coupled into an integrator 124.

Generally, because of the multi-source nature and because individual laser diodes have spatial intensity profiles that are somewhat Gaussian, the integrator 124 is typically required to generate a beam 126 with a rectangular cross section and with a uniform or improved spatial intensity profile.

The spatially homogeneous beam 126 is coupled to projection optics 128, which ensure that the beam has a rectangular cross-section and a planar phase front. This rectangular beam is then coupled through a spatial light modulator 130 to the media 12 held on the drum 110. A Hall effect focus motor 129 is used to adjust the focus position provided by the projection optics 128 under control of the controller 131.

In the present implementation, the spatial light modulator 130 comprises a linear array of grating light valves. The elements of the grating light valve array function as shutters that control the level of transmission to the media 12. Generally, each grating light valve comprises an optical cavity that will propagate light through the grating light valve to the media in response to the optical size of the cavity and the wavelength of light generated by the light source 122.

In other implementations, different spatial light modulators are used. For example, in some examples, the spatial light modulator 130 comprises a two-dimensional array of elements. Different types of spatial light modulators can also be used, such as spatial light modulators based on liquid crystal or tilt mirror technology.

In the present implementation, the operation of the spatial light modulator elements is controlled by an ON DAC system 132 and an OFF DAC system 134. These devices dictate the modulation level of the elements of the spatial light modulator 130.

In the present implementation, the elements of the spatial light modulator 130 are controlled in a binary fashion such that, during operation, they are either in an ON or transmissive state to expose the corresponding pixel on the media 12, or an OFF state or dark, non-transmissive state to leave the corresponding pixel on the media 12 unexposed. Whether the elements of the spatial light modulator 130 are in a transmissive or non-transmissive state depends on the size of their respective optical cavities. Each element of the spatial light modulator 130 has a corresponding ON digital-to-analog converter in the ON DAC system 132 and an OFF digital-to-analog converter in the OFF DAC system 134. These DAC's are loaded with ON and OFF control level data that dictate the drive voltages used to control the elements during the on and off states. These ON and OFF control level data are loaded into the ON DACS 132 and the OFF DACS 134 by the controller 131.

In other implementations, the elements are modulated to multiple levels, such as 256, to provide gray-scaling, for example.

A calibration sensor 150 is provided. In the present embodiment, this calibration sensor 150 comprises a photodiode 152 and a slit aperture 154. The combination of the photodiode 152 and the slit aperture 154 enable the controller 131 to monitor the operation of individual elements of the spatial light modulator 130 when the carriage is moved to the calibration position 156, such that it is opposite the calibration sensor 150.

In an alternative embodiment, the calibration sensor comprises a one dimensional or a two dimension sensor such as a CCD array. These linear or planar sensor arrays are useful to increase the speed of calibration and/or improve the uniformity of the illumination on a pixel by pixel basis.

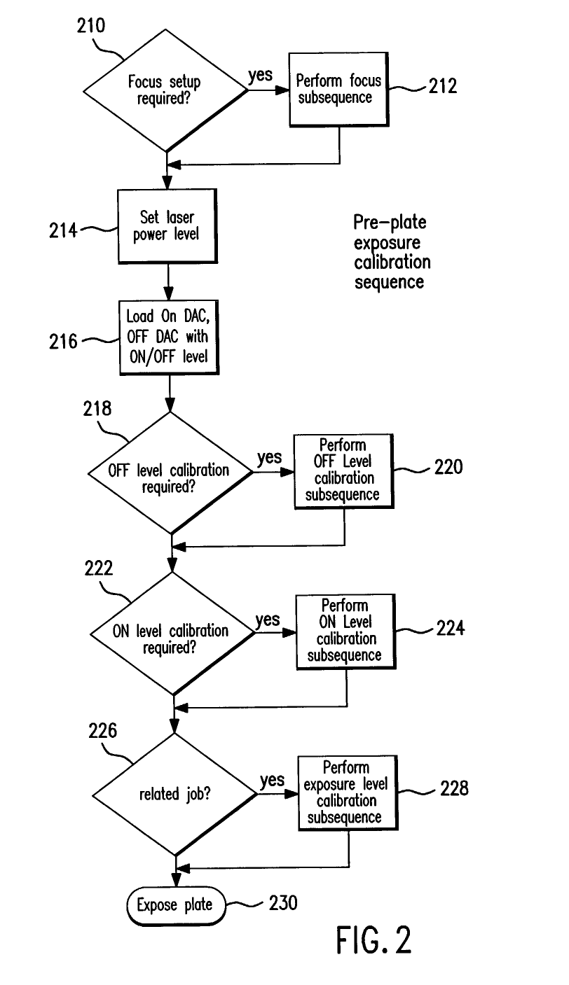

FIG. 2 is a flow diagram illustrating a pre-plate exposure calibration sequence.

Typically, this pre-plate exposure calibration sequence is run when the imagesetter or platesetter is first powered up. In an alternative implementation, this sequence is run before every exposure of the media 12 held on the drum 110.

Specifically, in step 210, the controller 131 determines whether a focus set-up subsequence should be run. If the controller 131 determines that focus set up is required, then the focus set up subsequence 212 is performed. Generally, this focus set-up occurs on a periodic basis. Alternatively, it can be performed before every plate exposure cycle. Sometimes, it is only performed when the machine is initially powered-up.

The laser power level is set in step 214. Specifically, the controller 131 sets the drive current that is supplied to the light source 122 in the carriage 120. Typically, the laser power level is read by the controller 131. It can be the last laser power setting that was used, or it can be a laser power setting that is set in the machine during factory calibration.

The ON DAC system 132 and the OFF DAC system 134 are next loaded with the ON/OFF control level data in step 216. In this step, the controller 131 loads the DAC systems 132, 134 with the voltage level data that is used to drive the elements of the spatial light modulator 130. Sometimes, the control level data for the elements are stored during a factory calibration step. In another implementation, this control level data is based upon the result of the last calibration sequence that was run on the imagesetter or platesetter.

Next, in step 218, the controller 131 determines whether the OFF level calibration is required. If it is, the OFF calibration subsequence is run in step 220.

Then, in step 222, the controller 131 determines whether ON level calibration is required. If ON level calibration is required, the ON level calibration subsequence is performed in step 224.

Finally, the system determines whether the present job is related to a previous job in step 226. The operator typically supplies this information. It is important, within the same job, that the average exposure levels are substantially the same. In this situation, the factory set exposure level may be too imprecise. As a result, in step 228, if this present job is related to a previous job, an exposure level calibration subsequence is run in step 228. Finally, in step 230, the media 12 on the drum 110 is exposed based upon the image data provided to the spatial light modulator 130 by the controller 131.

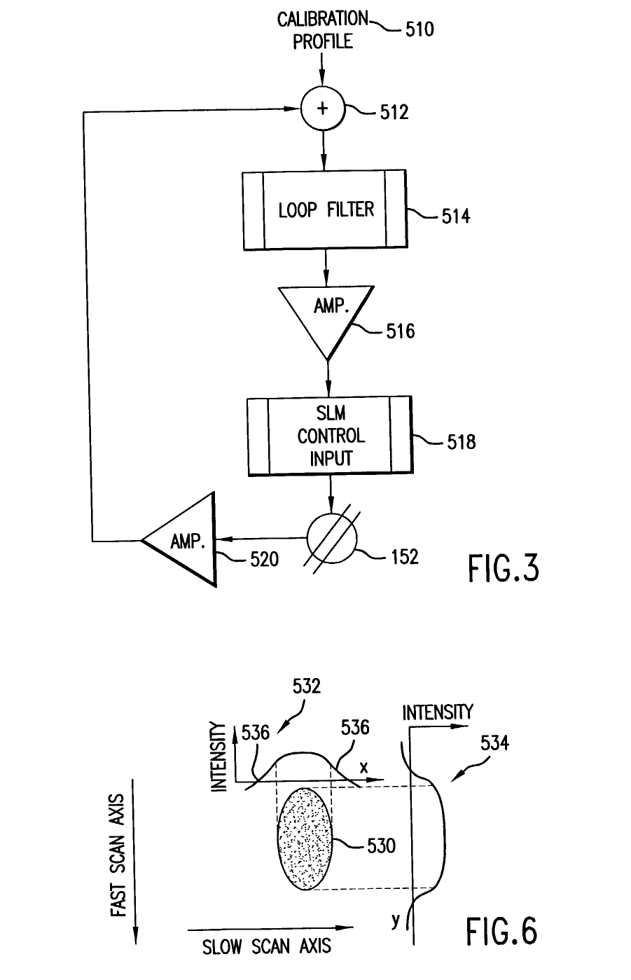

FIG. 3 is a flow diagram showing a servo calibration control loop for setting the On DAC control level data according to the present invention.

In more detail, a calibration profile 510 is used to define the intensity level that is to be transmitted through the SLM and more generally the exposure level provided by the SLM 130 across the elements of the SLM. The profile at a specific element is combined with a feedback signal in combiner 512. The result or error signal is then applied to a loop filter 514. This converts the input to the proper control voltage and specifically the transducer or element control voltage for the shutter elements. An amplifier 516 controls the gain. This results in the SLM control input for ON control level data 518, which are used to drive the specific elements of the SLM 130. The detector 552 detects the resulting transmitted intensity levels or more generally the exposure levels. This, through a gain setting amplifier 520 provides the feedback in the servo system.

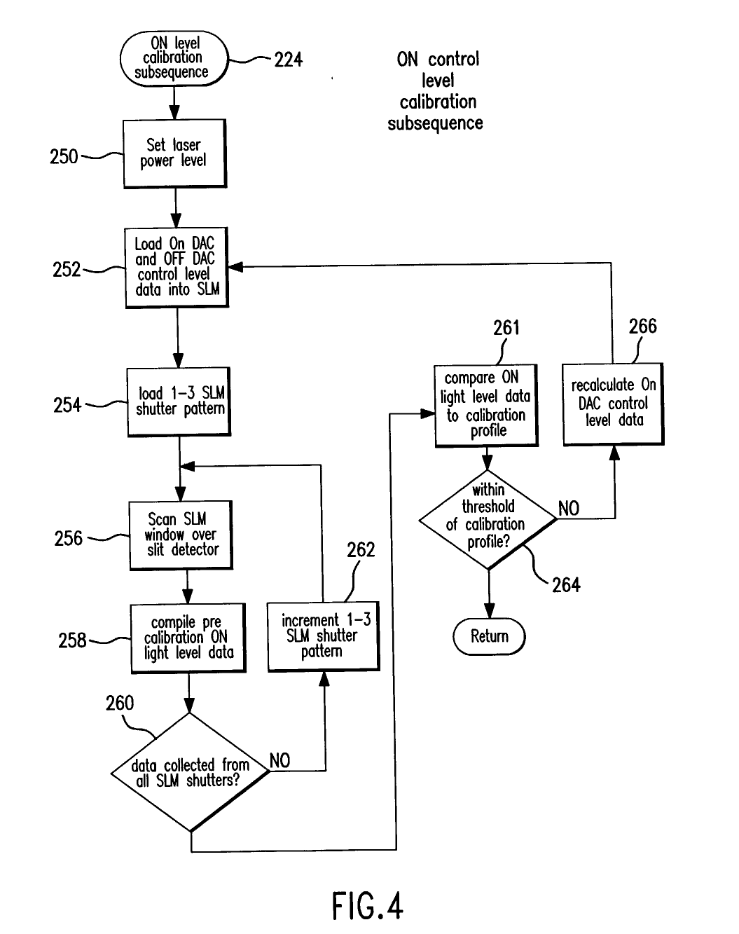

FIG. 4 is a flow diagram showing a specific implementation of the servo calibration control loop for the ON control level calibration subsequence 224 according to the present invention. Specifically, the laser power level is reset in step 250. Then, the ON DAC system 132 and the OFF DAC system 134 are loaded with ON and OFF control level data for the elements of the spatial light modulator 130 in step 252.

The controller 131 then further loads the spatial light modulator with a 1-ON, 3-OFF image data modulation sequence in step 254. This corresponds to an exposure pattern in which only every fourth element or shutter of the spatial light modulator 130 is in a transmissive state. Specifically, every fourth shutter is driven in response to the corresponding ON control level data held in its DAC of the ON DAC system 132. The remaining shutters are driven in response to their corresponding OFF control level data held in the OFF DAC system 134.

The carriage 120 is then moved on the track 140 to the calibration position 156 in which the spatial light modulator 130 is scanned opposite the aperture 154 of the calibration sensor 150 in step 256. The controller 130 monitors the output of the photodiode 152 and compiles an array of precalibration exposure or ON light level data in step 258. This exposure level data corresponds to the light that is transmitted through the spatial light modulator 130 and received at the image plane of the projection optics 128 for the media 12.

On the first pass through this process flow, however, the array of ON light level data is incomplete since data are gathered from 1 in 4 of the elements of the spatial light modulator 130. As a result, in step 260, it is determined whether data have been collected for all of the elements of the spatial light modulator 130. If not, then the ON-1, 3-OFF spatial light modulator shutter pattern is incremented in step 262 and the process steps 256 and 260 repeated. This way, the system generates a complete array of precalibration exposure level data for all of the elements of the spatial light modulator 130.

The 1-ON, 3-OFF shutter pattern, combined with successive scans is used to ensure that the controller 131 can discriminate the responses of the individual elements of the spatial light modulator 130. For high-resolution systems, the corresponding size of the pixels at the image plane is small. Using the 1-ON, 3-OFF shutter pattern allows the calibration sensor to have a reasonably sized aperture, yet discriminate the responses of individual elements.

In step 261, the controller 131 compares the ON light level data across the spatial light modulator to a calibration profile for the elements of the spatial light modulator 130. Generally, the controller 131 is determining whether there are large deviations in the level of exposure across the spatial light modulator 130 compared to the calibration profile.

If there is poor uniformity, as determined in step 264, the controller 131 calculates new ON control level data in step 266, which is then loaded in step 252. The process repeats to ensure that this new control level data provides uniformity within the threshold.

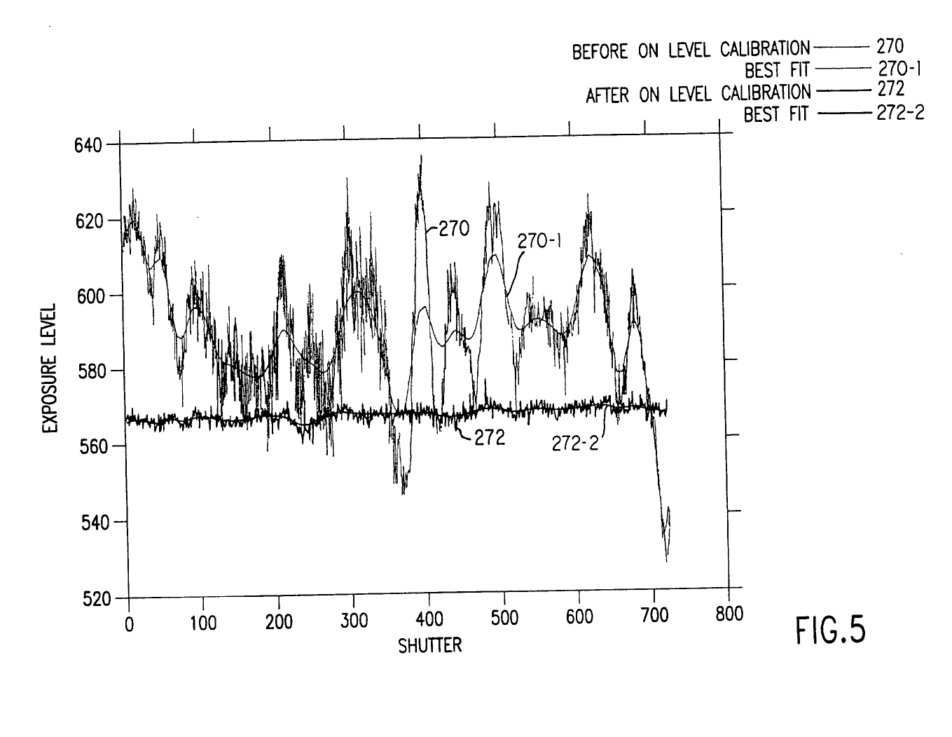

FIG. 5 is a plot of the exposure level data before and after calibration in the implemention in which the calibration profile is a constant level, i.e., flat, across the SLM 130. Specifically, the level of exposure for exposure or ON light level data array 270 shows wide variations in exposure. Specifically, the data varies from approximately a count of 640 to approximately 540 for an analog-to-digital converter that monitors the output of the photodiode 152.

The exposure level data compiled after the recalculation of the ON DAC control level data (step 266) has been loaded in the ON DAC system 132 corresponds to data array 272. Here, the exposure level generally is consistent, varying between 565 to 570 counts, showing good uniformity across the 700 shutters of the spatial light modulator 130, in one implementation.

In other implementations, non-flat calibration profiles are implemented. For example, non-flat profiles are important when a uniform exposure level across the SLM 130 is desired, but noise sources are present. For example, one source of noise is dynamics associated with the modulation of the SLM 130 at high speed. The noise source is instabilities in the mechanical system that cannot be measured during the calibration process. Further, non-flat calibration profiles can be used to compensate for exposure variation across individual pixels to achieve uniform modulation or spot size, or uniform intensity across the spot.

FIG. 6 is a schematic diagram of a pixel illumination spot 530 at a full width half max profile. The intensity parameter plots for the two axes are shown in insert plots 532 and 534. Specifically, the intensity is only generally a flat top. Instead, it varies continuously as a function of the X-axis and the Y-axis. Specifically, looking at plot 532, the X-axis intensity varies such that there exists substantial tails 536 in the intensity distribution. A similar phenomenon is present in the Y-axis intensity distribution. These tails exist because of diffractive effects and also modulation dynamics in the SLM. As a result, it is difficult to obtain an exact top hat or flattop profile. Moreover, a blurring effect exists due to the scan speed along the fast axis corresponding to the spinning of the drum 110.

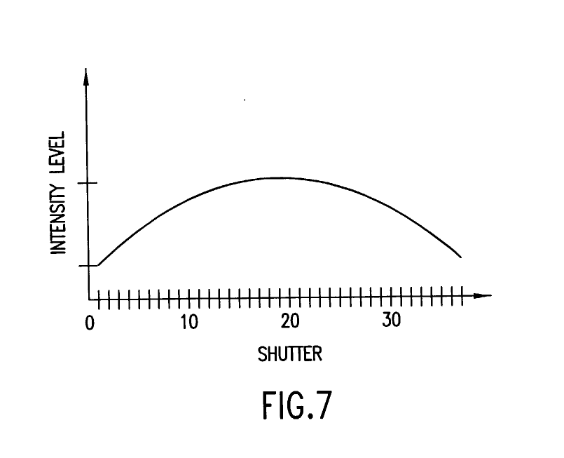

FIG. 7 shows a calibration profile in which the intensity level varies in a half sinusoid pattern across the shutters. In the illustrated example, the SLM comprises a total about 40 shutters. Such a pattern is used in one example to correct for nonuniform intensity distributions across the SLM. Generally, these pattern are used to correct for some engine exposure artifact measured with a separate tool or test platform. The bow implies a slowly varying signal with respect to spacing of the individual modulator elements.

In another example, a programmed spatial profile is provided on a shutter-to-shutter or element-to-element basis. This enables control of the optical shape of the intensity profile on a pixel scale or control of the specific profile of the illuminated pixel. For example, each pixel can be controlled to have more of a top hat or flat top intensity profile. Such a profile is most relevant to high-resolution print products.

Generally, this capability requires: (1) that the ratio of modulator shutter size to copy pixel size to be high, typically greater than 5 to 1, and preferably greater than 10 to 1; and (2) that the optical system modulation transfer function (MTF) likewise be an order of magnitude higher than the copy pixel. Presently, the size of the minimum copy pixel is set at or near the system optical MTF so that the maximum MTF is available at the image plane.

A related form of exposure error that is compensated is the gain imbalance between the pair of drivers that control the SLM modulator elements in an interleaved fashion in some implementations of the SLM 130. Odd shutters (elements) are driven from driver A, which supplies the drive voltages to each of the shutters. Even shutters are driven likewise from driver B. These drivers typically have a slight DAC gain difference resulting in a high spatial frequency exposure variation at the image plane.

The ON control level calibration subsequence measures these errors and cancels them out. However, it is also possible to pre-characterize each driver to determine a given fixed DAC offset for each driver. Then these offsets are implemented as a non-flat exposure correction target profile that, in this case, changes for every shutter. There are 4 interleaved drivers in the present system.

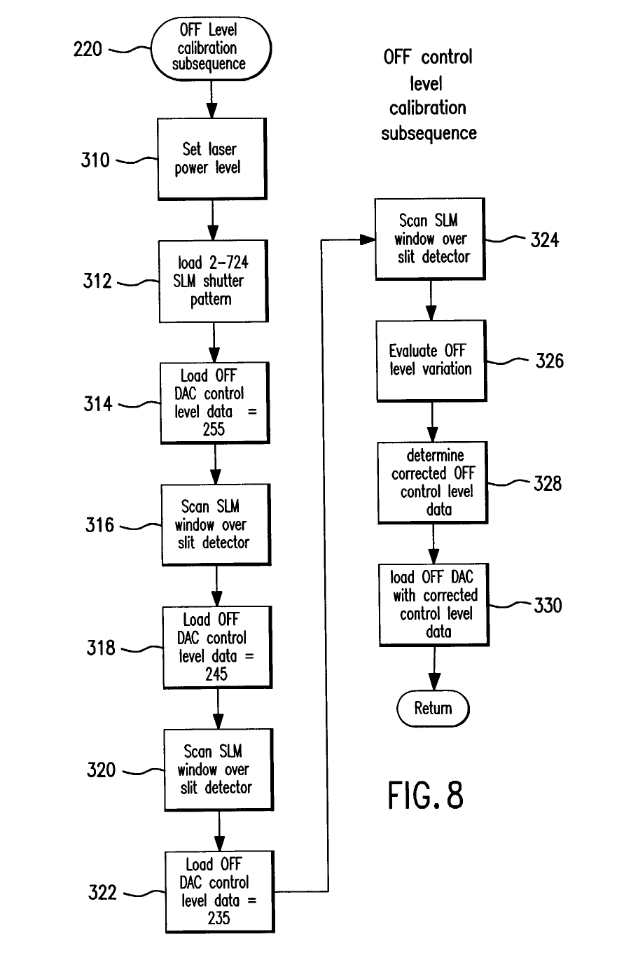

FIG. 8 shows the OFF control level calibration sequence 220. Specifically, in step 310, the laser power level is set. Then, in step 312, the spatial light modulator 130 is loaded with a 2-ON, 724-OFF shutter pattern. This shutter pattern corresponds to a pattern in which most of the elements of the spatial light modulator 130 are in a non-transmissive state. Then, the OFF DAC system 134 is loaded so that each element is driven with the same OFF control level data in step 314. Specifically, the digital-to-analog converters of the OFF DAC system 134 are loaded so that they all drive the elements of the spatial light modulator 130 to a level determined by a DAC count of 255. Then, in step 316, the carriage 120 is moved to the calibration position 156 and scanned so that the spatial light modulator 130 passes in front of the aperture 154 of the calibration sensor 150. The controller 131 monitors the response of the photodiode 152 during this scanning operation to generate an array of OFF or dark level data corresponding to this first DAC setting.

In step 318, the OFF DAC system 134 is loaded with a new OFF control level data. Specifically, in the specific implementation, it is loaded with a DAC count of 245, so that the elements of the spatial light modulator 130 are generally uniformly driven to this new off level. Then, in step 320, the carriage is again moved to the calibration position 156 and scanned over the spatial light modulator 130. This enables the controller 131 to generate a second array of OFF or dark level data corresponding to this second DAC setting.

Finally, in step 322, the OFF DAC system 134 is loaded with OFF control level data corresponding to a 235 DAC count. Then again, in step 324, the carriage 120 is again scanned. This scanning allows the controller 131, monitoring the output of the photodiode 152, to generate a third array of OFF level data corresponding to this third DAC setting for the elements of the spatial light modulator 130.

In step 326, the controller 131 evaluates the variation in the acquired OFF level data in the three data arrays. It then interpolates using the data of the three arrays to find an optimally uniform and optimally dark OFF control level setting for each of the elements of spatial light modulator in step 328. The resulting, new corrected OFF control level data is then loaded into the OFF DAC 134 in step 330.

Here again, in other implementations, non-uniform or non-flat spatial profiles can be implemented for the OFFcontrol level data. Again, in many instances, a flat top intensity profile is desirable for pixel by pixel exposure.

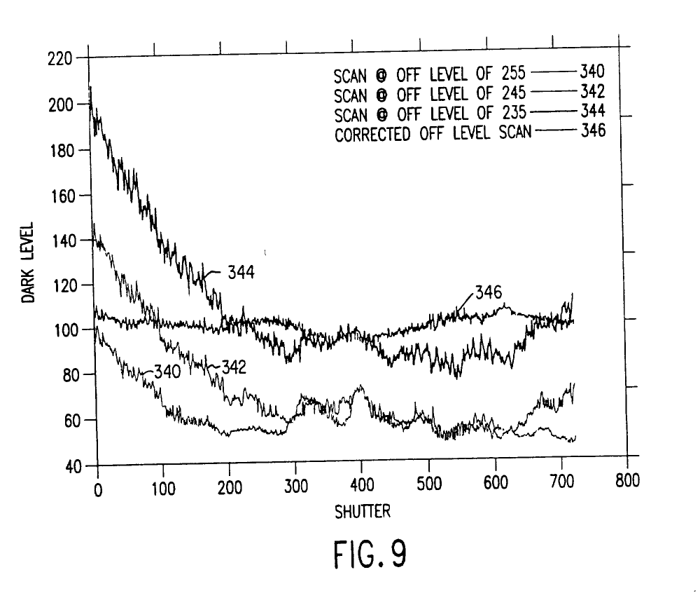

FIG. 9 is a plot of dark level data as a function of the shutter in the spatial light modulator 130. It shows that for the data arrays corresponding to the DAC setting of 255, see data 340, the DAC setting 245, see data array 342, and the DAC setting 235, see data array 344.

There is generally poor uniformity across the shutters of the spatial light modulator 130, illustrating that simply selecting a uniform DAC level for every element of the spatial light modulator 130 will generally yield poor performance. However, in step 328 of FIG. 8, the controller 131 uses the information from the three data arrays 340, 342, 344 to generate corrected OFF control level data by selecting counts between 235 and 255 for the various DACs of the OFF DAC system 134 by an interpolation process. The selection yields the corrected OFF light level data 346. This shows that a generally uniform level is achieved across the shutters of the spatial light modulator 130 using the data from the three arrays of dark level data collected in steps 314-322 of FIG. 8.

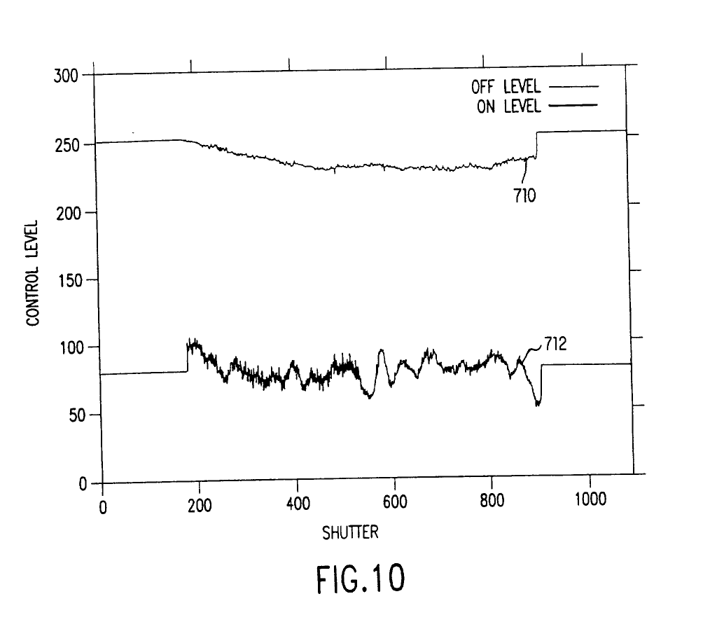

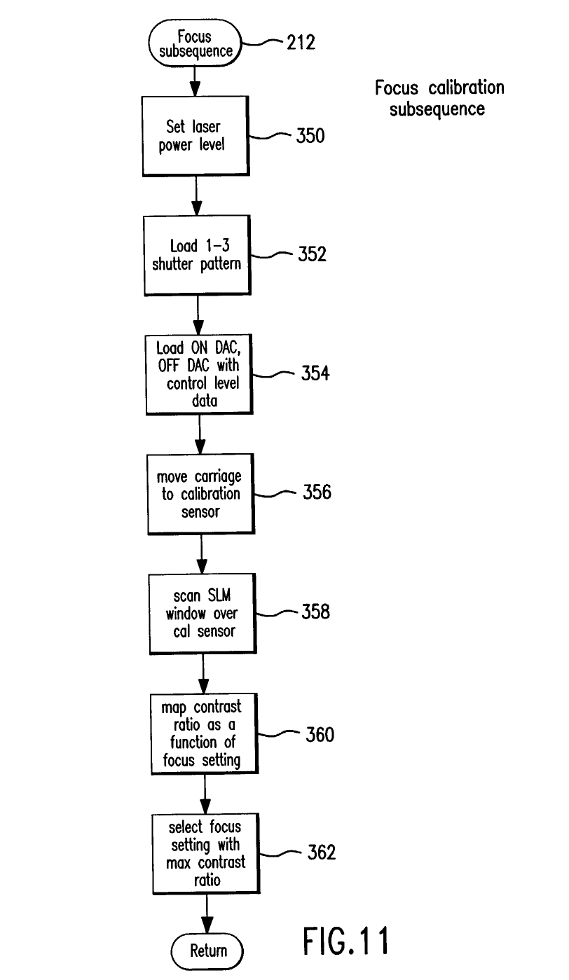

FIG. 10 is a plot of OFF control level data and ON control level data for the shutters of the spatial light modulator, across shutters 200-900. These control level data are generated during the calibration subsequences of FIGS. 3 and 5. Generally, the OFF level data 710 exhibits a trend across the spatial light modulator. This is typically due to wafer-level process variation during fabrication. The ON level data 712 tend to be less spatially correlated.

FIG. 11 is a flow diagram illustrating the focus subsequence 212. Specifically, the laser power level is set in step 350. Then, the elements of the spatial light modulator 130 are loaded with a 1-ON, 3-OFF shutter pattern in 352. To review, in this shutter pattern, only every fourth shutter is in a transmissive state.

In step 354, the ON DAC system 132 and the OFF DAC system 134 are loaded with the control level data. Further, in step 356, the carriage 120 is moved to the calibration position 156 in front of the calibration sensor 150 such that the spatial light modulator 130 is scanned opposite the aperture 154. This scanning occurs in step 358 while the focus setting for the projection optics 128 is changed. A scan is made for each fixed focus setting.

The controller 131 then monitors the response of the photodiode 152 to generate a contrast ratio map in step 360. A contrast ratio map plots the ON light level data and the OFF light level data for various focus settings. In step 362, the controller 131 selects the focus setting from the contrast map generated in step 360 to maximize the contrast ratio between the OFF light level data and the exposure or ON light level data.

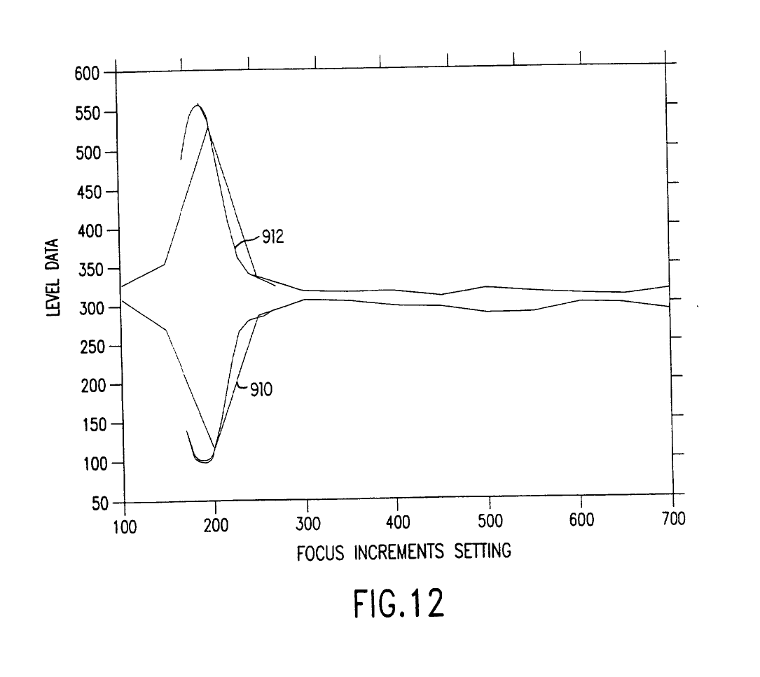

FIG. 12 is a plot of the contrast ratio map that is generated during the scan of step 358. Specifically, the exposure or ON level data 912 and the OFF or dark level data is provided for different focus settings for the projection optics 128 under control of the Hall motor 129. The maximum contrast ratio focus setting corresponds to the focus setting of approximately 190 to 200. The corresponding Hall motor position is stored as the best focus position by controller 131. In this way, the present invention sets the best focus setting to maximize the contrast ratio. In the spatial light modulator systems, this contrast ratio is a figure of merit determining their performance.

Alternatively, the system may hunt for best focus using a homing technique, but this approach still requires a series of fixed focus scans to evaluate the next focus position to take. Generally, focus selection is a compromise and it is chosen not only based on maximum sharpness (contrast ratio at a given point on the imaged line) but also for minimum sharpness variation over the line.

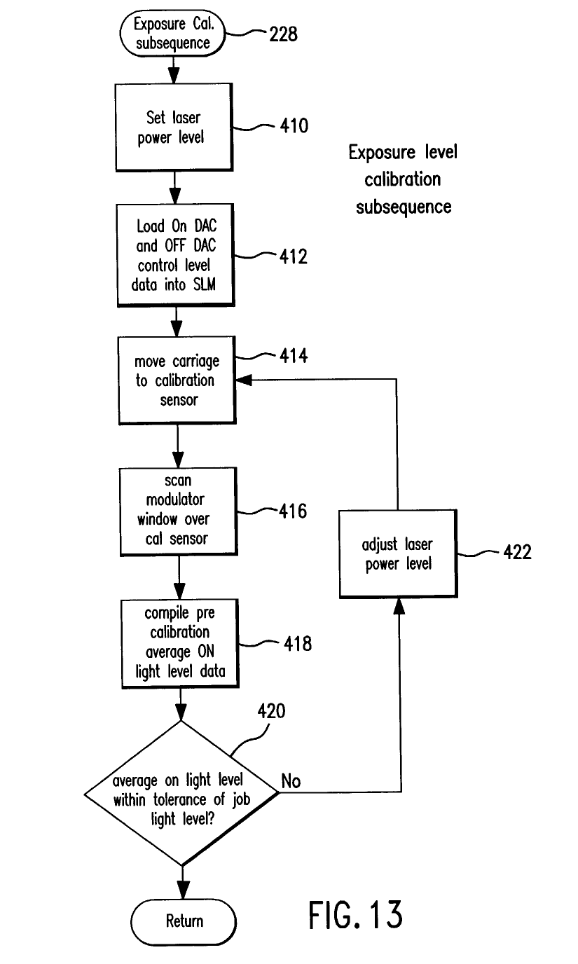

FIG. 13 is a flow diagram illustrating an exposure level calibration sub sequence 228. Many times, especially within the same job, it is important for the platesetter or imagesetter to expose successive plates within the same job at the same exposure setting.

Specifically, in the first step 410, the laser power level of the light source 122 is set. Then, the ON DAC system 132 and the OFF DAC system 134 are loaded with the control level data in step 412. Then, in step 414, the carriage 120 in moved to the calibration position 156 and the spatial light modulator 130 scanned in front of the aperture 154 of the calibration sensor 150 in step 416.

The controller 132 then monitors the output of the photodiode 152 and determines an average exposure level across the entire scan of the spatial light modulator 130 in front of the calibration sensor 150 in step 418. This detected average light level is then compared to the light level for a previous exposure of a plate for the same job or a similar pre-exposure calibration step. If it is determined to be outside an acceptable tolerance level, in step 420, the laser power level is adjusted by the controller 131 in step 422 and then, the sequence repeated to ensure that the average exposure level is the same for the two media exposures in the same job.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method for calibrating a spatial light modulator, the method comprising:
detecting intensity levels of light provided by elements of the spatial light modulator;
comparing the detected intensity levels to a calibration profile for the spatial light modulator; and
determining control levels for the elements of the spatial light modulator so that the provided intensity levels correspond to the calibration profile.

2. A method as claimed in claim 1, wherein the step of detecting the intensity levels comprises detecting light transmitted through the elements of the spatial light modulator.

3. A method as claimed in claim 1, wherein the step detecting and comparing functions are performed multiple times to function as a servo system to minimize error between the detected intensity levels and the calibration profile.

4. A method as claimed in claim 1, further comprising defining the calibration profile to have a uniformity threshold for the elements of the spatial light modulator.

5. A method as claimed in claim 1, further comprising defining the calibration profile to include variable intensity levels across the elements of the spatial light modulator.

6. A method as claimed in claim 1, further comprising defining the calibration profile to provide uniform exposure levels across the elements of the spatial light modulator.

7. A method as claimed in claim 1, further comprising modulating the elements of the spatial light modulator in a binary fashion during operation.

8. A method as claimed in claim 1, further comprising selecting the calibration profile to provide flat-top exposure profiles for pixel illumination by the spatial light modulator.

9. A method as claimed in claim 1, further comprising selecting the calibration profile to compensate for modulation dynamics of the spatial light modulator.

10. A method as claimed in claim 1, further comprising selecting the calibration profile to compensate for noise sources.

11. A method as claimed in claim 1, wherein step of detecting the intensity levels comprises detecting the light provided by the elements of the spatial light modulator with a slit detector.

12. A method as claimed in claim 1, wherein step of detecting the intensity levels comprises detecting the light provided by the elements of the spatial light modulator with a detector array.

13. A method as claimed in claim 1, further comprising selecting the calibration profile to achieve a target pixel illumination profile.
